(19) United States
(12) Patent Application Publication
(10) Pub. No.: US 2026/0225427 A1
(43) Pub. Date: Aug. 6, 2026

(54) HEAT PUMP WITH INTERNAL HEAT GENERATION OF MULTI-PHASE COMPRESSOR

(71) Applicant: Ford Global Technologies, LLC, Dearborn, MI (US)

(72) Inventor: Scott Thomas Vehige, Woodhaven, MI (US)

(73) Assignee: Ford Global Technologies, LLC, Dearborn, MI (US)

(21) Appl. No.: 19/043,989

(22) Filed: Feb. 3, 2025

(51) Int. Cl. B60H 1/00

(52) U.S. Cl. CPC B60H 1/00899

(57) ABSTRACT

A heat pump system includes a multi-phase compressor motor that is configured to drive a compressor pump. At least one phase of electrical power supplied to the compressor motor may be modulated whereby the compressor motor generates additional heat. The additional heat is utilized to heat refrigerant before the refrigerant enters the compressor pump. Heating refrigerant may increase a pressure of the refrigerant during cold operating conditions whereby a minimum refrigerant suction pressure can be maintained when the heat pump is operated in a cold environment.

### FIELD OF THE DISCLOSURE

The present disclosure generally relates to heat pumps, and more specifically to a heat pump that utilizes heat from a three-phase compressor to operate at lower ambient temperatures.

### BACKGROUND OF THE DISCLOSURE

Heat pump systems have been used in motor vehicles and the like. When heat pumps are operated in cold ambient temperatures, the temperature of refrigerant may be reduced, and pressure of the refrigerant may also be reduced. This may limit the operation of heat pumps at lower temperatures.

### SUMMARY OF THE DISCLOSURE

An aspect of the present disclosure is a method of heating refrigerant of a refrigerant loop of a vehicle heat pump system having a compressor including a multi-phase (e.g. three-phase) compressor motor. The method includes measuring suction pressure up stream of an inlet of the compressor, and heating refrigerant to maintain the suction pressure at or above a predefined minimum suction pressure. Heating the refrigerant includes modulating voltage by reducing a voltage of at least a first of the three phases of electrical power supplied to the three-phase compressor motor during operation of the heat pump relative to at least a second of the three phases, whereby the voltages of the three phases are not equal, thereby causing the compressor motor to generate additional heat relative to an amount of heat generated when voltages of the three phases are equal. The method further includes causing at least some of the additional heat to be transferred to refrigerant in the refrigerant loop.

Embodiments of the first aspect of the present disclosure can include any one or a combination of the following features:

The method may optionally include monitoring a temperature of the compressor motor and/or a temperature of an inverter of the compressor motor, and the method may also include limiting voltage modulation of at least one of the three phases such that: 1) the temperature of the compressor motor does not exceed a predefined maximum allowable motor temperature and/or: 2) the temperature of the inverter does not exceed a predefined maximum allowable inverter temperature.

The method may optionally include causing the three phases to have equal voltages when the measured suction pressure is at or above a predefined desired suction pressure.

The method may optionally include utilizing differences between measured suction pressure and a target suction pressure to control a reduction of the voltage of at least one phase of the electrical power supplied to the compressor motor.

The method may optionally include increasing differences in voltage between at least two phases if differences between measured suction pressure and a target suction pressure increase, and decreasing differences in voltage between at least two phases if differences between measured suction pressure and a target suction pressure decrease.

The method may optionally include utilizing differences between measured suction pressure and a target suction pressure as inputs to a Proportional Integral Differential (PID) control, wherein the PID control controls differences in voltage between at least two phases to decrease differences between measured suction pressure and the target suction pressure.

The method may optionally include modulating only one phase of the electrical power supplied to the compressor motor if modulating only one phase of the electrical power supplied to the compressor motor is sufficient to maintain the measured suction pressure at or above a predefined desired suction pressure.

The method may optionally include modulating a second phase of the electrical power supplied to the compressor motor if modulating only one phase of the electrical power supplied to the compressor motor is not sufficient to maintain the measured suction pressure at or above a predefined desired suction pressure.

The method may optionally include causing refrigerant to circulate around the compressor motor whereby the refrigerant is heated by the compressor motor before the refrigerant is compressed.

Another aspect of the present disclosure is a heat pump system for vehicles. The heat pump system includes a coolant loop, and a refrigerant loop that is thermally coupled to the coolant loop by a heat exchanger. The refrigerant loop includes a compressor having a three-phase compressor motor that is configured to rotate a compressor pump to compress refrigerant in the refrigerant loop. The heat pump system further includes a controller that is configured to modulate a voltage of at least one of the three phases of electrical power supplied to the three-phase compressor motor during operation of the heat pump, such that the voltages of the three phases are not equal, and the compressor motor generates additional heat relative to an amount of heat generated when the voltages of the three phases are equal to thereby heat refrigerant and maintain suction pressure of refrigerant upstream of the compressor pump.

Embodiments of the second aspect of the present disclosure can include any one or a combination of the following features:

The three-phase compressor motor may optionally include an inverter, and the controller may be configured to: 1) monitor a temperature of the compressor motor and/or the inverter, and: 2) reduce voltage modulation to prevent the temperature of the compressor motor from exceeding a predefined maximum allowable motor temperature and/or to prevent the temperature of the inverter from exceeding a predefined maximum allowable inverter temperature.

The controller is optionally configured to provide the compressor motor with electrical power having three phases, wherein the three phases have equal voltages when the measured suction pressure is at or above a predefined desired suction pressure.

The controller is optionally configured to utilize differences between measured suction pressure and a target suction pressure to control modulation of the voltage of at least one phase of the electrical power supplied to the compressor motor.

The controller is optionally configured to: 1) increase voltage modulation if differences between measured suction pressure and a target suction pressure increase, and/or: 2) decrease voltage modulation if differences between measured suction pressure and a target suction pressure decrease.

The controller is optionally configured to utilize differences between measured suction pressure and a target suction pressure as inputs to a Proportional Integral Differential (PID) control that adjusts voltage modulation to minimize differences between measured suction pressure and a target suction pressure.

The controller is optionally configured to modulate only one phase of the electrical power supplied to the compressor motor if modulating only one phase of the electrical power supplied to the compressor motor is sufficient to maintain the measured suction pressure above a predefined minimum suction pressure.

The controller is optionally configured to modulate a second phase of the electrical power supplied to the compressor motor in addition to the one phase if modulation of a second phase is necessary to maintain the measured suction pressure above the predefined minimum suction pressure.

The heat pump system may optionally include a refrigerant path extending around the three-phase compressor motor whereby at least some heat generated due to modulating voltage to the three-phase compressor motor is transferred to refrigerant before the refrigerant is compressed.

Another aspect of the present disclosure is a heat pump system for vehicles. The heat pump system includes a coolant loop and a refrigerant loop that is thermally coupled to the coolant loop. The refrigerant loop includes a compressor having a multi-phase compressor motor that is configured to rotate a compressor pump to compress refrigerant in the refrigerant loop. A refrigerant path extends around at least a portion of the multi-phase compressor motor whereby heat from the multi-phase compressor motor is transferred to refrigerant flowing through the refrigerant path before the refrigerant is compressed by the compressor pump. The heat pump system further includes a controller that is configured to decrease a voltage of at least one of the phases of electrical power supplied to the multi-phase compressor motor during operation of the heat pump such that voltages of the phases are not equal, whereby the compressor motor generates additional heat relative to an amount of heat generated when the voltages of the phases are equal to thereby heat refrigerant before the refrigerant enters an inlet of the compressor pump to maintain a suction pressure of refrigerant upstream of the compressor pump above a predefined minimum suction pressure.

The multi-phase compressor motor may optionally comprise a three-phase electric motor, and the controller is optionally configured to decrease a voltage of two phases of the electrical power supplied to the compressor motor if modulation of two phases is necessary to maintain the measured suction pressure above the predefined minimum suction pressure.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a partially schematic top plan view of a motor vehicle including a heat pump according to an aspect of the present disclosure;

FIG. 2 is a schematic of a heat pump according to an aspect of the present disclosure;

FIG. 3 is a schematic showing operation of a three-phase electric induction motor;

FIG. 4 is a partially schematic cross-sectional view of a compressor according to an aspect of the present disclosure; and

FIG. 5 is a schematic showing operation of a three-phase compressor according to an aspect of the present disclosure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

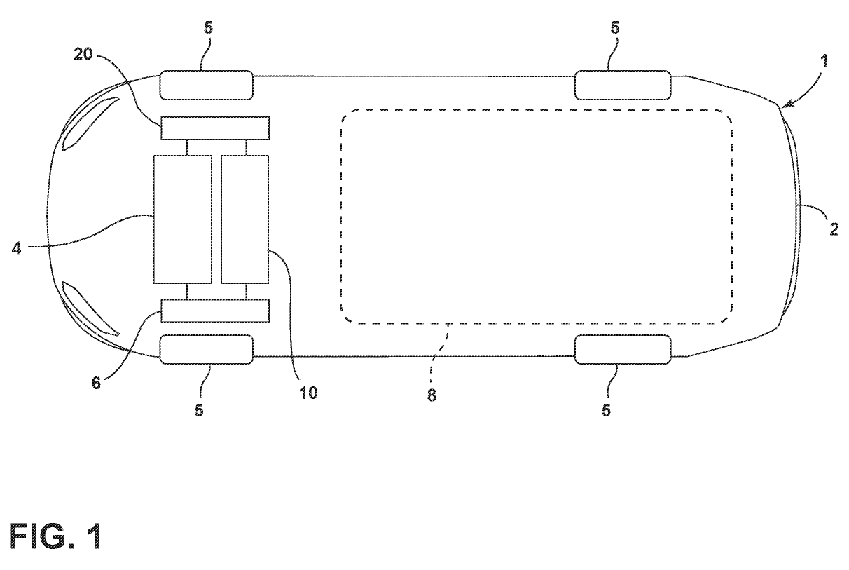

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the terms “or” and “and/or,” when used in a list of two or more items, means that any one of the listed items can be employed by itself, or any combination of two or more of the listed items can be employed. For example, if a composition or device is described as containing or comprising components A, B, or C, the composition or device can contain (include) A alone; B alone; C alone; A and B in combination; A and C in combination; B and C in combination; or A, B, and C in combination. If a composition or device is described as containing or comprising components A and/or B and/or C, the composition or device can contain (include) A alone; B alone; C alone; A and B in combination; A and C in combination; B and C in combination; or A, B, and C in combination.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

With reference to FIG. 1, a vehicle 1 may include a body 2 and a power drive 4 that is operatively connected to wheels 5 to provide for motion of vehicle 1. Power drive 4 may comprise, for example, an electric drive system that is operatively connected to a high voltage (“HV”) battery 20. Vehicle 1 may also include a heat pump 10 that may be configured to heat and/or cool a cabin 8 of vehicle 1. As discussed below, refrigerant of heat pump 10 may be heated to increase a pressure of the refrigerant to permit heat pump 10 to operate at lower ambient temperatures. Heat pump 10 may also be utilized to heat and/or cool HV battery 20. A controller 6 may be operatively connected to the power drive 4 and heat pump 10. It will be understood that controller 6 may comprise a plurality of individual controllers and/or control modules or units as required for particular application.

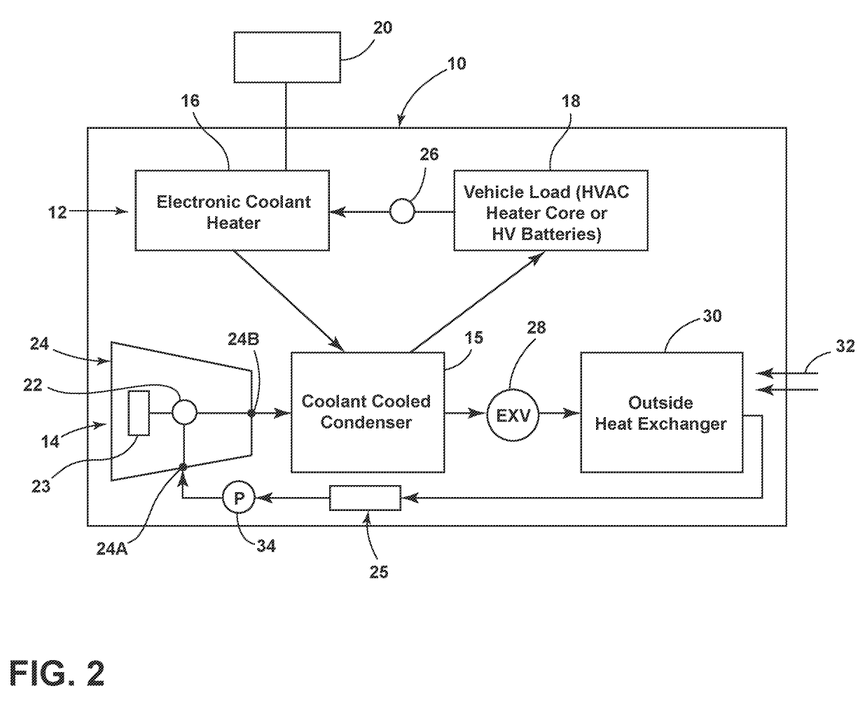

With reference to FIG. 2, heat pump 10 may include a coolant loop 12 that is thermally coupled to a refrigerant loop 14 by a heat exchanger such as condenser 15. Coolant loop 12 may include a vehicle thermal load 18, a coolant pump 26, and an optional electronic coolant heater 16. Vehicle load 18 may comprise one or more heat exchangers such as a HVAC heater core that is configured to provide heat for cabin 8 and/or a heat exchanger that is configured to provide heat to an HV battery or the like. Heat pump 10 may include one or more pumps 26 that are configured to circulate coolant (e.g. liquid) in coolant loop 12.

Refrigerant loop 14 may include a compressor 24 having a multi-phase electric motor 23 (e.g. three-phase electric motor) that drives a compressor pump 22. Compressor 24 may have a minimum allowable pressure at inlet 24A of compressor pump 22. If operating (ambient) temperatures decrease, pressure at inlet 24A may decrease due to the temperature reduction. As discussed in more detail below, the present disclosure provides for heating refrigerant before the refrigerant enters compressor pump 22 to thereby prevent the pressure of the refrigerant from reaching a minimum allowable pressure at inlet 24A of compressor pump 22 at low ambient temperatures. Heating the refrigerant may also reduce an ambient temperature at which the pressure of the refrigerant reaches the minimum allowable pressure at inlet 24A of compressor pump 22 (i.e. if the refrigerant cannot be heated enough to keep the pressure at inlet 24A above the minimum allowable pressure, heating the refrigerant will nevertheless reduce the ambient temperature at which the pressure reaches the minimum).

During operation, compressor 24 compresses refrigerant whereby the refrigerant exits outlet port 24B of compressor 24 and flows through condenser 15 and expansion valve 28. The refrigerant then flows through the heat exchanger 30. The heat exchanger 30 may comprise, for example, an outside heat exchanger that is exposed to ambient air 32. After flowing through heat exchanger 30, the refrigerant flows to an optional electrically powered heater 25. The electrical heater 25 may heat the refrigerant before the refrigerant flows into an input port 24A of compressor 24.

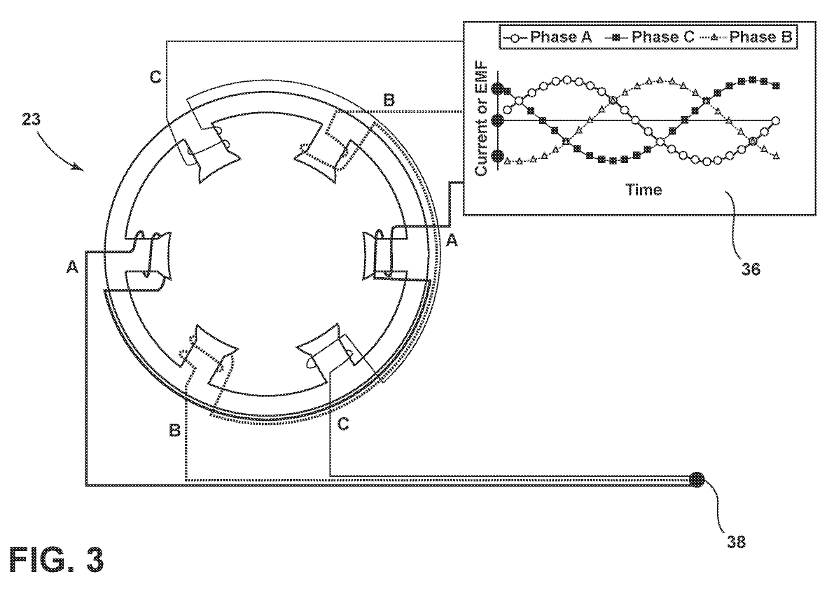

With further reference to FIG. 3, three-phase motor 23 generally includes a three-phase input 36 and a neutral connection 38. In general, the voltage or current of the three-phase input 36 may be equal during “normal” operations to provide efficient operation. However, as discussed in more detail below, one or more of the phases may be modulated whereby the voltage and/or current of the input phases are not equal. This may cause motor 23 to operate in a less efficient manner and generate heat. In general, the amplitude (voltage) of one or more phases 36 may be modulated (increased or decreased relative to an optimum or “normal” voltage) such that motor 23 generates heat without rotating compressor pump 22.

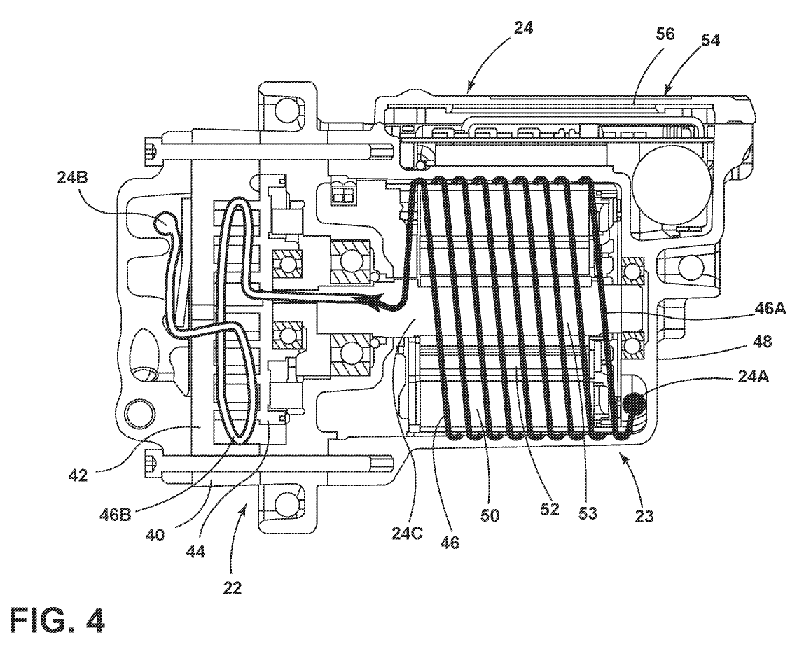

With further reference to FIG. 4, compressor pump 22 of compressor 24 may optionally comprise a scroll compressor having a frame or housing 40, a fixed scroll 42, and an orbiting scroll 44. Orbiting scroll 44 may rotate when three-phase electric motor 23 is actuated to compress refrigerant (e.g. when electric motor 23 is actuated without phase modulation preventing rotation of motor 23). It will be understood that numerous pumps/compressors may be utilized, and the present disclosure is not limited to the configuration of FIG. 4.

Referring again to FIG. 4, three-phase electric motor 23 of compressor 24 may include a housing 48, a stator 50, and a rotor 52. Rotor 52 may be rotatably supported in housing 48 by a shaft 53. The motor 23 may also include an inverter 54 that is configured to control operation of motor 23.

During operation, refrigerant flows from inlet 24A of compressor 24 along a refrigerant path 46 to outlet 24B. The refrigerant path 46 includes a first portion 46A that extends around motor 23, and a second portion 46B extending through compressor pump 22. Path 46 may comprise an inlet 24C whereby refrigerant enters compressor pump 22 at inlet 24C after the refrigerant exits first portion 46A of refrigerant path 46. First portion 46A of refrigerant path 46 may comprise, for example, a helical pathway formed by metal tubing or other suitable material to thereby transfer heat from the electric motor 23 to the refrigerant flowing along first portion 46A of path 46. In general, the second portion 46B of the refrigerant path may be substantially similar to the flow path of known compressor pumps.

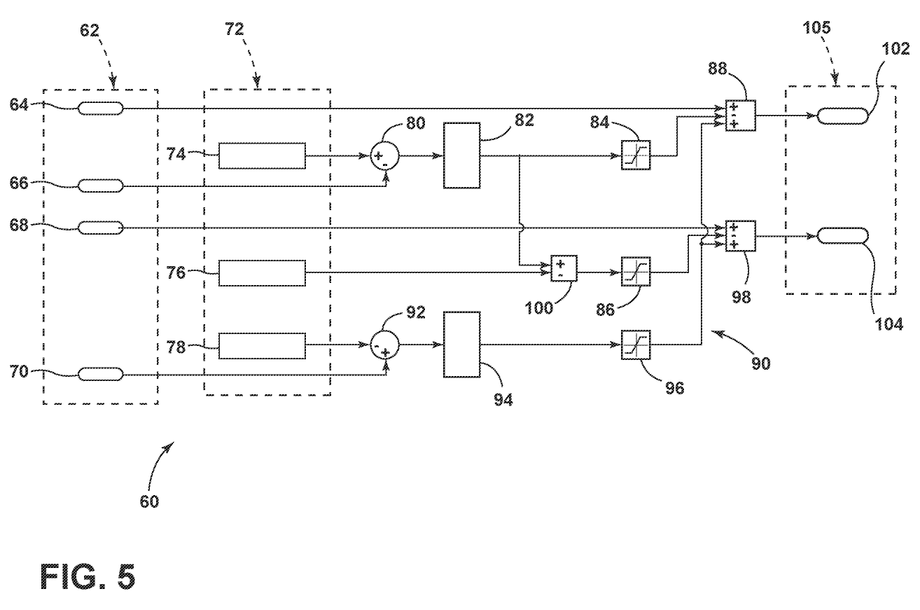

With further reference to FIG. 5, a control system or method 60 may be utilized to control three-phase electric motor 23. Inputs 62 may include a measured voltage 64 of a first phase (“phase one”), a measured suction pressure 66, a measured voltage 68 of a second phase (“Phase two”), and a measured inverter temperature 70. The voltages 64 and 68 may be measured utilizing one or more suitable sensors associated with the lines A, B, and/or C (FIG. 3). The measured suction pressure 66 may comprise a pressure reading from a pressure sensor 34 (FIG. 2). The pressure sensor 34 may be positioned at or adjacent suction inlet 24A (FIGS. 2 and 4) or adjacent inlet 24C (FIG. 4). In general, if sensor 34 is positioned at inlet 24A, pressure sensor 34 will measure pressure of refrigerant before the refrigerant flows through the first portion 46A of path 46 around compressor motor 23 (i.e. before the refrigerant is heated by compressor motor 23). If pressure sensor 34 is positioned at inlet 24C of compressor pump 22, the pressure sensor 34 will measure pressure of refrigerant after the refrigerant has been heated due to flowing through the refrigerant path 46 extending around compressor motor 23, but prior to compression of the refrigerant by the compressor pump 22. The present disclosure is not limited to a specific pressure sensor or sensors, and a plurality of pressure sensors may be positioned along the refrigerant flow path upstream of compressor pump 22 as required for a particular application.

The measured inverter temperature 70 (FIG. 5) may be measured utilizing a temperature sensor 56 (FIG. 4) that may be positioned on or in housing 48 of motor 23 to thereby measure a temperature of inverter 54.

Compressor pump 22 may have a predefined minimum suction pressure whereby compressor pump 22 cannot operate properly if the measured suction pressure 66 drops below the minimum allowable suction pressure of the compressor pump 22. Also, the inverter 54 may have a predefined maximum allowable temperature, and control 60 may utilize the measured inverter temperature 70 as an input. Specifically, control 60 may be configured to operate the compressor 24 such that the measured inverter temperature 70 does not exceed the maximum allowable temperature.

Control 60 may utilize calibratable parameters 72 in addition to inputs 62. The calibratable parameters 72 may include a suction pressure target 74, a single-phase reduction limit 76, and an inverter temperature limit 78. The single-phase reduction limit 76 may comprise a functional limit on the reduction of a single phase (i.e. a maximum allowable voltage reduction of one phase when the voltages of the other two phases have not been reduced). Control 60 may be configured such that if the voltage of only one phase has been reduced, the reduction does not exceed the single-phase reduction limit 76.

A difference between measured suction pressure 66 and suction pressure target 74 is taken at 80 (FIG. 5), and the difference is input into a control 82. The control 82 may comprise, for example, a Proportional Integral Derivative (PID) control or other suitable control scheme that utilizes the differences output from 80. The output of control 82 is supplied to a reduction limiter 84, and the output of the reduction limiter 84 is supplied to a summation 88. Summation 88 also receives the measured voltage 64 of phase one and the output of inverter temperature limitation 90. The inverter temperature limitation 90 may comprise a difference 92 between measured inverter temperature 70 and inverter temperature limit 78, with the difference determined at 92 being an input to a control 94. Control 94 may comprise PID control or other suitable control scheme. The output of the control 94 is provided to a voltage limiter 96, and the output of the voltage limiter 96 is provided to the summation 88 as noted above.

Referring again to FIG. 5, the measured voltage 68 of phase two may be input into a summation 98. A junction 100 receives output from control 82 and the single phase reduction limit 76, and the output of junction 100 is provided to a reduction limiter 86 that sets a lower limit on a voltage of the second electrical phase. Output of the reduction limiter 86 is provided to block 98.

The outputs of summations 88 and 98 may comprise commands 105. Commands 105 may comprise first and second voltage commands 102 and 104, respectively. First voltage command 102 comprises a voltage control of a first voltage phase of the electric power supply to electric motor 23, and command 104 comprises a voltage command of a second phase of the electric power supplied to three-phase electric motor 23.

In general, control 60 may be configured to minimize a difference between measured suction pressure 66 and suction pressure target 74 by initially reducing first voltage command 102 to reduce voltage of the first phase provided to electric motor 23 to increase heat generated by electric motor 23. As discussed above in connection with FIG. 4, heat from motor 23 is transferred to refrigerant flowing through path 46 to thereby heat the refrigerant and raise the pressure of the refrigerant before the refrigerant enters the compressor pump 22. If reductions in the first phase voltage are insufficient to maintain suction pressure, control 60 reduces voltage of phase two (command 104) to generate additional heat that is transferred to refrigerant to thereby increase pressure of the refrigerant before the refrigerant enters the compressor pump 22. The voltage reductions are limited by the functional limits 84 and 86. Also, differences between measured inverter temperature 70 and the inverter temperature limit 78 are utilized to limit the voltage commands 102 and 104 whereby the temperature of inverter 54 (FIG. 4) does not exceed the maximum allowable temperature of inverter 54. In general, this permits the heat pump 10 to operate at lower ambient temperatures.

The voltage phase commands 102 and 104 may be configured to permit three-phase electric motor 23 to continue rotating to minimize differences between measured suction pressure 66 and suction pressure target 74, despite a reduction in efficiency due to the phase manipulation. In general, if control 60 is not able to maintain a desired or required minimum measured suction pressure 66, the control 60 may disable motor 23. In general, an inability to maintain a suction pressure above a predefined limit may be due to a measured suction pressure that has dropped below suction pressure target 74 (e.g. a threshold pressure below target suction pressure 74) or a measured inverter temperature 70 that is greater than the inverter temperature limit 78.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method of heating refrigerant of a refrigerant loop of a vehicle heat pump system having a compressor including a three-phase compressor motor, the method comprising:
measuring suction pressure upstream of an inlet of the compressor; and
heating refrigerant to maintain the suction pressure at or above a predefined minimum suction pressure;
wherein heating refrigerant includes: 1) modulating voltage by reducing a voltage of at least a first of the three phases of electrical power supplied to the three-phase compressor motor during operation of the heat pump relative to at least a second of the three phases, whereby the voltages of the three phases are not equal, thereby causing the compressor motor to generate additional heat relative to an amount of heat generated when voltages of the three phases are equal; and: 2) causing at least some of the additional heat to be transferred to refrigerant in the refrigerant loop.

2. The method of claim 1, including:
monitoring a temperature of the compressor motor and/or a temperature of an inverter of the compressor motor; and
limiting voltage modulation of at least one of the three phases such that: 1) the temperature of the compressor motor does not exceed a predefined maximum allowable motor temperature and/or: 2) the temperature of the inverter does not exceed a predefined maximum allowable inverter temperature.

3. The method of claim 1, including:
causing the three phases to have equal voltages when the measured suction pressure is at or above a predefined desired suction pressure.

4. The method of claim 3, including:
utilizing differences between measured suction pressure and a target suction pressure to control a reduction of the voltage of at least one phase of the electrical power supplied to the compressor motor.

5. The method of claim 4, including:
increasing differences in voltage between at least two phases if differences between measured suction pressure and a target suction pressure increase; and
decreasing differences in voltage between at least two phases if differences between measured suction pressure and a target suction pressure decrease.

6. The method of claim 5, wherein:
utilizing differences between measured suction pressure and a target suction pressure as inputs to a Proportional Integral Differential (PID) control, wherein the PID control controls differences in voltage between at least two phases to decrease differences between measured suction pressure and the target suction pressure.

7. The method of claim 5, including:
modulating only one phase of the electrical power supplied to the compressor motor if modulating only one phase of the electrical power supplied to the compressor motor is sufficient to maintain the measured suction pressure at or above a predefined desired suction pressure.

8. The method of claim 7, including:
modulating a second phase of the electrical power supplied to the compressor motor if modulating only one phase of the electrical power supplied to the compressor motor is not sufficient to maintain the measured suction pressure at or above a predefined desired suction pressure.

9. The method of claim 1, including:
causing refrigerant to circulate around the compressor motor whereby the refrigerant is heated by the compressor motor before the refrigerant is compressed.

10. A heat pump system for vehicles, the heat pump system comprising:
a coolant loop;
a refrigerant loop that is thermally coupled to the coolant loop by a heat exchanger, the refrigerant loop including a compressor having a three-phase compressor motor that is configured to rotate a compressor pump to compress refrigerant in the refrigerant loop; and
a controller configured to modulate a voltage of at least one of the three phases of electrical power supplied to the three-phase compressor motor during operation of the heat pump such that the voltages of the three phases are not equal and the compressor motor generates additional heat relative to an amount of heat generated when the voltages of the three phases are equal to thereby heat refrigerant and maintain suction pressure of refrigerant upstream of the compressor pump.

11. The heat pump system of claim 10, wherein:
the three-phase compressor motor includes an inverter; and
the controller is configured to: 1) monitor a temperature of the compressor motor and/or the inverter, and: 2) reduce voltage modulation to prevent the temperature of the compressor motor from exceeding a predefined maximum allowable motor temperature and/or to prevent the temperature of the inverter from exceeding a predefined maximum allowable inverter temperature.

12. The heat pump system of claim 10, wherein:
the controller is configured to provide the compressor motor with electrical power having three phases, wherein the three phases have equal voltages when the measured suction pressure is at or above a predefined desired suction pressure.

13. The heat pump system of claim 12, wherein:
the controller is configured to utilize differences between measured suction pressure and a target suction pressure to control modulation of the voltage of at least one phase of the electrical power supplied to the compressor motor.

14. The heat pump system of claim 13, wherein:
the controller is configured to: 1) increase voltage modulation if differences between measured suction pressure and a target suction pressure increase, and/or: 2) decrease voltage modulation if differences between measured suction pressure and a target suction pressure decrease.

15. The heat pump system of claim 14, wherein:
the controller is configured to utilize differences between measured suction pressure and a target suction pressure as inputs to a Proportional Integral Differential (PID) control that adjusts voltage modulation to minimize differences between measured suction pressure and a target suction pressure.

16. The heat pump system of claim 14, wherein:
the controller is configured to modulate only one phase of the electrical power supplied to the compressor motor if modulating only one phase of the electrical power supplied to the compressor motor is sufficient to maintain the measured suction pressure above a predefined minimum suction pressure.

17. The heat pump system of claim 16, wherein:
the controller is configured to modulate a second phase of the electrical power supplied to the compressor motor in addition to the one phase if modulation of a second phase is necessary to maintain the measured suction pressure above the predefined minimum suction pressure.

18. The heat pump system of claim 10, including:
a refrigerant path extending around the three-phase compressor motor whereby at least some heat generated due to modulating voltage to the three-phase compressor motor is transferred to refrigerant before the refrigerant is compressed.

19. A heat pump system for vehicles, the heat pump system comprising:
a coolant loop;
a refrigerant loop that is thermally coupled to the coolant loop, the refrigerant loop including a compressor having a multi-phase compressor motor that is configured to rotate a compressor pump to compress refrigerant in the refrigerant loop, and including a refrigerant path extending around at least a portion of the multi-phase compressor motor whereby heat from the multi-phase compressor motor is transferred to refrigerant flowing through the refrigerant path before the refrigerant is compressed by the compressor pump; and
a controller configured to decrease a voltage of at least one of the phases of electrical power supplied to the multi-phase compressor motor during operation of the heat pump such that voltages of the phases are not equal, whereby the compressor motor generates additional heat relative to an amount of heat generated when the voltages of the phases are equal to thereby heat refrigerant before the refrigerant enters an inlet of the compressor pump to maintain a suction pressure of refrigerant upstream of the compressor pump above a predefined minimum suction pressure.

20. The heat pump system of claim 19, wherein:
the multi-phase compressor motor comprises a three-phase electric motor;
the controller is configured to decrease a voltage of two phases of the electrical power supplied to the compressor motor if modulation of two phases is necessary to maintain the measured suction pressure above the predefined minimum suction pressure.
